(19) United States
(12) Patent Application Publication
(10) Pub. No.: US 2024/0262364 A1
(43) Pub. Date: Aug. 8, 2024

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi (JP)

(72) Inventor: Kenta Kumazaki, Tokyo-to (JP)

(73) Assignee: TOYOTA JIDOSHA KABUSHIKI KAISHA, Toyota-shi (JP)

(21) Appl. No.: 18/522,824

(22) Filed: Nov. 29, 2023

(30) Foreign Application Priority Data
Feb. 2, 2023 (JP) 2023-014753

(51) Int. Cl. B60W 30/18; B60W 60/00

(52) U.S. Cl. CPC B60W 30/18163; B60W 60/001

(57) ABSTRACT

A vehicle controller includes a processor configured to detect that a host vehicle is towing a towed vehicle, detect a host vehicle lane being traveled by the host vehicle, determine whether the host vehicle is required to make a lane change to a target lane different from the host vehicle lane, and control the host vehicle to make a lane change from the host vehicle lane to the target lane, when the lane change is required. The processor sets start timing of the lane change earlier when towing of a towed vehicle by the host vehicle is detected than when towing of a towed vehicle by the host vehicle is not detected.

### CROSS-REFERENCE TO RELATED APPLICATION

This application claims priority to Japanese Patent Application No. 2023-014753 filed on Feb. 2, 2023, the entire contents of which are herein incorporated by reference.

### FIELD

The present disclosure relates to a vehicle controller, a method, and a computer program for vehicle control.

### BACKGROUND

Motion of a vehicle towing another vehicle sometimes differs from motion of a vehicle that is not towing another vehicle. In autonomous driving control of a vehicle towing another vehicle, it is therefore desirable to control the towing vehicle, taking account of motion of the vehicle that differs, depending on whether or not it is towing another vehicle. In view of this, a technique has been proposed to control a vehicle differently, depending on whether a towed vehicle is coupled (see Japanese Patent JP6327423B).

A vehicle control system disclosed in JP6327423B sets a greater distance between a host vehicle and another vehicle in the vicinity of the host vehicle when a towing state in which the host vehicle is towing an object is detected than when a towing state is not detected. In particular, the vehicle control system prohibits lane change control when the towing state is detected.

### SUMMARY

A vehicle may be required to make a lane change even when towing a towed vehicle. Thus, prohibition of lane change control of a vehicle towing a towed vehicle as in the above-described technique may cause inconvenience to a driver. On the other hand, a vehicle with a towed vehicle has a larger total volume and thus passes through a larger area at the time of a lane change than the towing vehicle alone. As a result, motion of a vehicle towing a towed vehicle may give rise to a feeling of pressure relating to another vehicle traveling in the vicinity of the towing vehicle when the towing vehicle makes a lane change.

It is an object of the present disclosure to provide a vehicle controller that enables a vehicle towing a towed vehicle to make a lane change under autonomous driving control and that can reduce a feeling of pressure relating to another vehicle traveling in an area therearound.

According to an embodiment, a vehicle controller is provided, which includes a processor configured to: detect that a host vehicle under autonomous driving control is towing a towed vehicle, detect a host vehicle lane being traveled by the host vehicle among a plurality of lanes included in a road being traveled by the host vehicle, determine whether the host vehicle is required to make a lane change to a target lane different from the host vehicle lane in a section from the current position of the host vehicle to a predetermined distance away, by referring to a map and the host vehicle lane, and control the host vehicle to make a lane change from the host vehicle lane to the target lane, when a lane change is required. The processor sets start timing of a start of the lane change earlier when towing of a towed vehicle by the host vehicle is detected than when towing of a towed vehicle by the host vehicle is not detected.

In some embodiments, the processor of the vehicle controller sets the start timing of the lane change earlier when towing of a towed vehicle by the host vehicle is detected in the case where the target lane is congested or predicted to be congested than when towing of a towed vehicle by the host vehicle is detected in the case where the target lane is not congested.

In some embodiments, depending on weather around the host vehicle, the processor adjusts the start timing of the lane change for the case where towing of a towed vehicle by the host vehicle is detected.

According to another embodiment, a method for vehicle control is provided, which includes detecting that a host vehicle under autonomous driving control is towing a towed vehicle; detecting a host vehicle lane being traveled by the host vehicle among a plurality of lanes included in a road being traveled by the host vehicle; determining whether the host vehicle is required to make a lane change to a target lane different from the host vehicle lane in a section from the current position of the host vehicle to a predetermined distance away, by referring to a map and the host vehicle lane; and controlling the host vehicle to make a lane change from the host vehicle lane to the target lane, when the lane change is required. Controlling the lane change from the host vehicle lane to the target lane includes setting start timing of a start of the lane change earlier when towing of a towed vehicle by the host vehicle is detected than when towing of a towed vehicle by the host vehicle is not detected.

According to still another embodiment, a non-transitory recording medium that stores a computer program for vehicle control is provided, which includes instructions causing a processor mounted on a host vehicle to execute a process including detecting that the host vehicle under autonomous driving control is towing a towed vehicle; detecting a host vehicle lane being traveled by the host vehicle among a plurality of lanes included in a road being traveled by the host vehicle; determining whether the host vehicle is required to make a lane change to a target lane different from the host vehicle lane in a section from the current position of the host vehicle to a predetermined distance away, by referring to a map and the host vehicle lane; and controlling the host vehicle to make a lane change from the host vehicle lane to the target lane, when the lane change is required. Controlling the lane change from the host vehicle lane to the target lane includes setting start timing of a start of the lane change earlier when towing of a towed vehicle by the host vehicle is detected than when towing of a towed vehicle by the host vehicle is not detected.

The vehicle controller according to the present disclosure has an effect of enabling a vehicle towing a towed vehicle to make a lane change under autonomous driving control and being able to reduce a feeling of pressure relating to another vehicle traveling in an area therearound.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4 illustrates the difference in start timing of a lane change between when towing of a towed vehicle is not detected and when towing of a towed vehicle is detected.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller executes autonomous driving control of travel of a host vehicle capable of towing a towed vehicle. More specifically, the vehicle controller can execute lane change control of the host vehicle. In this control, the vehicle controller sets start timing of a lane change earlier when towing of a towed vehicle by the host vehicle is detected than when towing of a towed vehicle by the host vehicle is not detected.

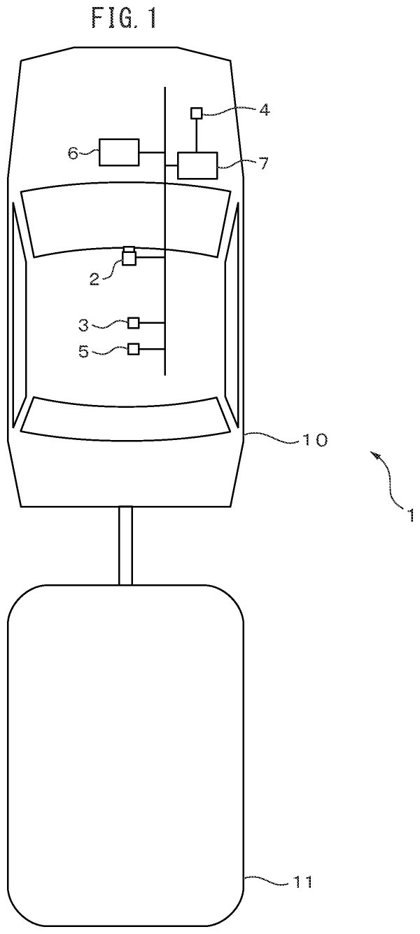

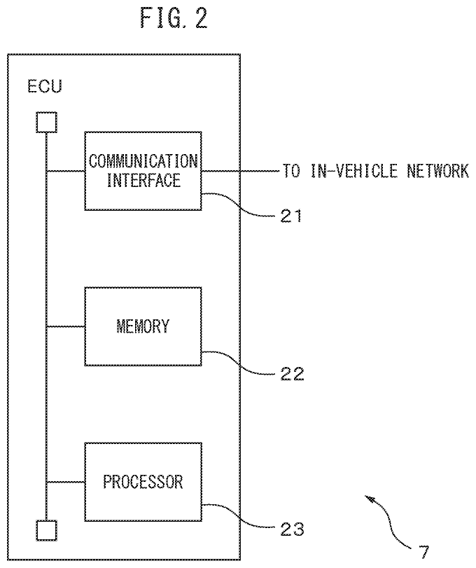

FIG. 1 schematically illustrates the configuration of a vehicle control system equipped with the vehicle controller. FIG. 2 illustrates the hardware configuration of an electronic control unit, which is an embodiment of the vehicle controller. In the present embodiment, the vehicle control system 1, which is mounted on a vehicle 10 and controls the vehicle 10, includes a camera 2, a GPS receiver 3, a motion sensor 4, a wireless communication terminal 5, a storage device 6, and an electronic control unit (ECU) 7, which is an example of the vehicle controller. The camera 2, the GPS receiver 3, the wireless communication terminal 5, and the storage device 6 are communicably connected to the ECU 7 via an in-vehicle network conforming to a standard such as a controller area network. The motion sensor 4 is also communicably connected to the ECU 7. The vehicle control system 1 may further include a range sensor (not illustrated) that measures the distances from the vehicle 10 to objects around the vehicle 10, such as LiDAR or radar. The vehicle control system 1 may further include a navigation device (not illustrated) for searching for a route to a destination.

The vehicle 10 further includes equipment for towing a towed vehicle 11, such as a tow hook, and is thereby capable of towing the towed vehicle 11.

The camera 2, which is an example of a vehicle exterior sensor, includes a two-dimensional detector constructed from an array of optoelectronic transducers, such as CCD or C-MOS, having sensitivity to visible light and a focusing optical system that forms an image of a target region on the two-dimensional detector. The camera 2 is mounted, for example, in the interior of the vehicle 10 so as to be oriented, for example, to the front of the vehicle 10. The camera 2 takes a picture of a region in front of the vehicle 10 every predetermined capturing period (e.g., 1/30 to 1/10 seconds), and generates an image representing the region. Each image obtained by the camera 2 is an example of an external sensor signal representing the surroundings of the vehicle 10. The vehicle 10 may include multiple cameras taking pictures in different orientations or having different focal lengths.

Every time an image is generated, the camera 2 outputs the generated image to the ECU 7 via the in-vehicle network.

The GPS receiver 3 receives GPS signals from GPS satellites at predetermined intervals, and determines the position of the vehicle 10, based on the received GPS signals. The GPS receiver 3 outputs positioning information indicating the result of determination of the position of the vehicle 10 based on the GPS signals to the ECU 7 via the in-vehicle network at predetermined intervals. Instead of the GPS receiver, the vehicle 10 may include a receiver that receives positioning signals from satellites of another satellite positioning system to determine the position of the vehicle 10.

The motion sensor 4 is a sensor for sensing motion of the vehicle 10, and includes, at least, a torque sensor that detects torque applied to a drive shaft of driving wheels, and an acceleration sensor that detects the acceleration of the vehicle 10. The vehicle control system 1 may include different types of motion sensors 4. For example, the motion sensor 4 may include a speed sensor or a gyro sensor. Every time a sensor signal indicating motion of the vehicle 10 is generated, the motion sensor 4 outputs the generated sensor signal to the ECU 7. A sensor signal generated by the motion sensor 4 (e.g., a torque-indicating signal generated by the torque sensor, an acceleration/deceleration-indicating signal generated by the acceleration sensor, or a speed-indicating signal generated by the speed sensor) is an example of a vehicle motion signal indicating motion of the vehicle 10.

The wireless communication terminal 5 communicates with a wireless base station by wireless in conformity with a predetermined standard of mobile communications. The wireless communication terminal 5 receives map information including a high-precision map used for autonomous driving control from a map server via the wireless base station, and outputs the received map information to the storage device 6 via the in-vehicle network.

The storage device 6, which is an example of a storage unit, includes, for example, a hard disk drive, a nonvolatile semiconductor memory, or an optical medium and an access device therefor. The storage device 6 stores a high-precision map.

The storage device 6 further includes a processor for executing, for example, a process to update the map information and a process related to a request from the ECU 7 to read out the high-precision map. For example, every time the vehicle 10 moves a predetermined distance, the storage device 6 transmits a request to obtain map information, together with the current position of the vehicle 10, to the map server via the wireless communication terminal 5. The storage device 6 receives map information including a high-precision map of a predetermined region around the current position of the vehicle 10 from the map server via the wireless communication terminal 5, and stores the high-precision map included in the received map information. In addition, when a request from the ECU 7 to read out a map is received, the storage device 6 cuts out that portion of the high-precision map stored therein which includes the current position of the vehicle 10 and which represents a region smaller than the predetermined region, and outputs the cutout portion to the ECU 7 via the in-vehicle network. The high-precision map includes information used for autonomous driving control of the vehicle 10, such as the number of lanes of each road section, the width of each lane, regulation speeds, road markings including lane lines, and various traffic signs.

The ECU 7 executes autonomous driving control of the vehicle 10. In particular, the ECU 7 executes lane change control to cause the vehicle 10 to make a lane change as necessary during execution of autonomous driving control of the vehicle 10.

As illustrated in FIG. 2, the ECU 7 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 7 to another device. Every time an image is received from the camera 2, the communication interface 21 passes the received image to the processor 23. Every time positioning information is received from the GPS receiver 3, the communication interface 21 passes the positioning information to the processor 23. Every time a sensor signal is received from the motion sensor 4, the communication interface 21 passes the sensor signal to the processor 23. Further, the communication interface 21 passes a high-precision map read from the storage device 6 to the processor 23.

The memory 22, which is another example of a storage unit, includes, for example, volatile and nonvolatile semiconductor memories, and stores various types of data used in a vehicle control process executed by the processor 23. For example, the memory 22 stores images of the surroundings of the vehicle 10 received from the camera 2, positioning information of the vehicle 10 received from the GPS receiver 3, measured values indicating motion of the vehicle 10 in sensor signals received from the motion sensor 4, and a high-precision map read from the storage device 6. In addition, the memory 22 stores parameters of the camera 2, such as the focal length, the orientation, and the mounted position, as well as various parameters for specifying a classifier for object detection used for detecting features. Further, the memory 22 temporarily stores various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

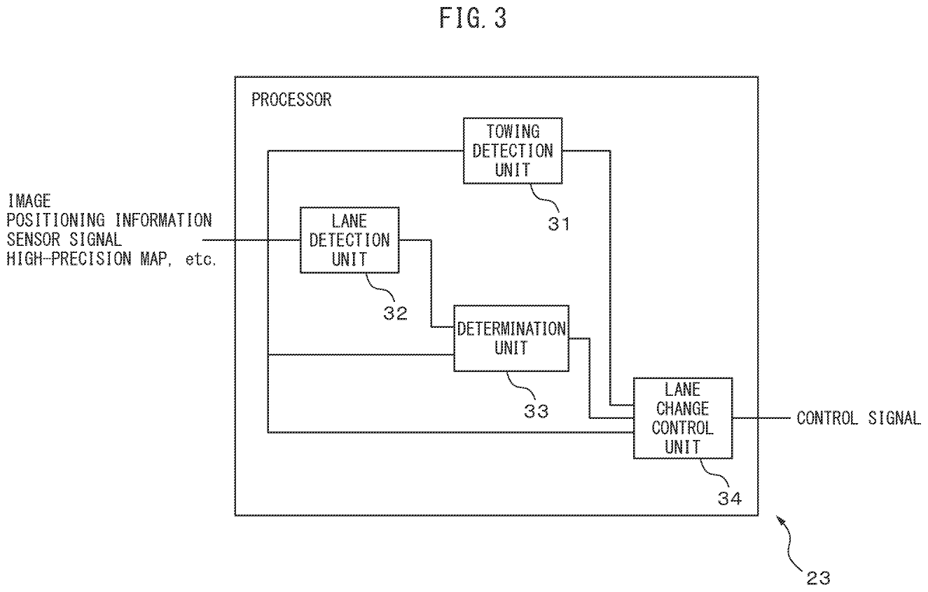

FIG. 3 is a functional block diagram of the processor 23, related to the vehicle control process. The processor 23 includes a towing detection unit 31, a lane detection unit 32, a determination unit 33, and a lane change control unit 34. These units included in the processor 23 are functional modules, for example, implemented by a computer program executed by the processor 23, or may be dedicated operating circuits provided in the processor 23.

In the present embodiment, the processor 23 changes start timing of lane change control executed on the vehicle 10, depending on whether towing of a towed vehicle 11 by the vehicle 10 is detected. In the following, towing of a towed vehicle 11 by the vehicle 10 will be referred to simply as a “towing of a towed vehicle 11.”

The towing detection unit 31 detects that the vehicle 10 is towing a towed vehicle 11. In this case, it is assumed that towing of a towed vehicle 11 by the vehicle 10 will continue during driving of the vehicle 10. Thus, once determination is made regarding detection of towing of a towed vehicle 11, the towing detection unit 31 does not need to redetermine as to whether towing of a towed vehicle 11 is detected until the ignition switch of the vehicle 10 is turned off.

For example, the towing detection unit 31 uses sensor signals indicating measured values of acceleration and torque at acceleration of the vehicle 10, which are obtained from the motion sensor 4 when the vehicle 10 is in a predetermined state, for detection of towing of a towed vehicle 11. The towing detection unit 31 compares the acceleration with a towing determination threshold corresponding to the torque, and detects towing of a towed vehicle 11, when the acceleration is less than the towing determination threshold. When the acceleration is not less than the towing determination threshold, the towing detection unit 31 does not detect towing of a towed vehicle 11. Towing determination thresholds corresponding to different torque values are prestored in the memory 22.

The predetermined state may be, for example, a state in which the vehicle 10 is stopped at a location without a gradient in the travel direction or is traveling at a fixed predetermined speed on a road without a gradient in the travel direction. The towing detection unit 31 determines the presence or absence of a gradient in the travel direction of the vehicle 10 by referring to the high-precision map and the position of the vehicle 10 indicated by the latest positioning signal obtained by the GPS receiver 3. When there is no gradient in the travel direction of the vehicle 10, the towing detection unit 31 further determines whether the vehicle 10 is in the predetermined state, based on a sensor signal indicating the speed of the vehicle 10 obtained from the speed sensor, which is an example of the motion sensor 4.

When towing of a towed vehicle 11 is detected, the towing detection unit 31 may further estimate the weight of the towed vehicle 11. In this case, the towing detection unit 31 identifies a weight corresponding to the measured torque and acceleration by referring to a reference table representing the relationship between torque and acceleration and the weight of the towed vehicle 11, and determines the identified weight as an estimated weight of the towed vehicle 11.

In the case where the equipment for towing a towed vehicle 11 is provided with a sensor that senses connection of a towed vehicle 11, the towing detection unit 31 may detect towing of a towed vehicle 11 when a sensor signal from the sensor indicates that a towed vehicle 11 is connected.

The towing detection unit 31 notifies the lane change control unit 34 of the result of determination whether towing of a towed vehicle 11 is detected.

The lane detection unit 32 detects a lane being traveled by the vehicle 10 (hereafter a “host vehicle lane”) among a plurality of lanes included in a road being traveled by the vehicle 10. In the present embodiment, the lane detection unit 32 compares an image representing the surroundings of the vehicle 10 generated by the camera 2 with the high-precision map to detect a host vehicle lane. For example, assuming the position and orientation of the vehicle 10, the lane detection unit 32 projects features on or around the road detected from an image onto the high-precision map or those features on or around the road in the vicinity of the vehicle 10 which are represented in the high-precision map onto the image. The features on or around the road may be, for example, road markings such as lane lines or stop lines, or curbstones. The lane detection unit 32 then estimates the position of the vehicle 10 to be the position and orientation of the vehicle 10 for the case where the features detected from the image match those represented in the high-precision map the best.

The lane detection unit 32 uses initial values of the assumed position and orientation of the vehicle 10 and parameters of the camera 2, such as the focal length, the height of the mounted position, and the orientation, to determine the positions in the high-precision map or the image to which the features are projected. As the initial values of the position and orientation of the vehicle 10 is used the position of the vehicle 10 measured by the GPS receiver 3 or the position obtained by correcting, with odometry information, the position and orientation of the vehicle 10 estimated at the last detection of the host vehicle lane. The lane detection unit 32 then calculates the degree of matching between the features on or around the road detected from the image and the corresponding features represented in the high-precision map (e.g., the inverse of the sum of squares of the distances between corresponding features).

The lane detection unit 32 repeats the above-described processing while varying the assumed position and orientation of the vehicle 10, and estimates the actual position of the vehicle 10 to be the assumed position and orientation for the case where the degree of matching is a maximum. The lane detection unit 32 then refers to the high-precision map to identify a lane including the position of the vehicle 10 as the host vehicle lane being traveled by the vehicle 10.

In addition, the lane detection unit 32 may input an image into a classifier that has been trained to detect detection target features from an image, thereby detecting these features. As such a classifier, the lane detection unit 32 can use a deep neural network (DNN) having architecture of a convolutional neural network (CNN) type, e.g., Single Shot MultiBox Detector or Faster R-CNN. Alternatively, as such a classifier, the lane detection unit 32 may use a DNN having architecture of a self-attention network (SAN) type, such as Vision Transformer, or a classifier based on another machine learning technique, such as an AdaBoost classifier. Such a classifier is trained in advance with a large number of training images representing a detection target feature in accordance with a predetermined training technique, such as backpropagation, so as to detect this feature from an image.

According to a modified example, the lane detection unit 32 may detect the position of the host vehicle lane, based on the numbers of lane lines detected in regions in an image corresponding to the left and right of the vehicle 10, respectively. For example, in the case where the number of lane lines detected from a region corresponding to the right of the vehicle 10 is one and where the number of lane lines detected from a region corresponding to the left of the vehicle 10 is two, the lane detection unit 32 detects the right lane with respect to the travel direction of the vehicle 10 among two lanes included in a road being traveled by the vehicle 10 as a host vehicle lane.

The lane detection unit 32 notifies the determination unit 33 of the position of the host vehicle lane in the road being traveled by the vehicle 10.

The determination unit 33 determines whether the vehicle 10 is required to make a lane change from the host vehicle lane to another lane different from the host vehicle lane in a predetermined section from the current position of the vehicle 10 to a predetermined distance away. In the following, a lane to which the vehicle 10 will move by one or more lane changes will be referred to as a “target lane.”

For example, the determination unit 33 determines that a lane change to a target lane is required, in the case where the host vehicle lane differs from a lane leading toward a destination of the vehicle 10 and where the lane leading toward a destination diverges from the road being traveled by the vehicle 10, which includes the host vehicle lane, in the predetermined section. In this case, the target lane is the lane leading toward a destination.

To determine whether the host vehicle lane differs from the lane leading toward a destination of the vehicle 10, the determination unit 33 refers to a travel route to the destination of the vehicle 10 received by the ECU 7 from a navigation device (not illustrated), the current position of the vehicle 10, and the high-precision map. The determination unit 33 determines whether in the predetermined section there is a branch point at which the lane leading toward a destination diverges from the road being traveled by the vehicle 10. When there is a branch point, the determination unit 33 determines whether the host vehicle lane differs from the lane leading toward a destination. When the host vehicle lane differs from the lane leading toward a destination, the determination unit 33 determines to apply lane change control one or more times in which the lane leading toward a destination is the target lane.

When it is determined that a lane change to the target lane is required in the predetermined section, the determination unit 33 notifies the lane change control unit 34 of the result of determination. The determination unit 33 further notifies the lane change control unit 34 of the position of the branch point at which the target lane diverges from the road being traveled by the vehicle 10 as well as the positions of the host vehicle lane and the target lane in the road being traveled by the vehicle 10.

When notified by the determination unit 33 of the result of determination that the vehicle 10 is required to make a lane change in the predetermined section, the lane change control unit 34 executes lane change control to move the vehicle 10 to the target lane.

To this end, the lane change control unit 34 sets start timing at which the vehicle 10 will start a lane change, based on the number of lanes across which the vehicle 10 needs to move from the host vehicle lane to the target lane, i.e., the number of lane changes. For example, the lane change control unit 34 calculates the sum of the distance required for a single lane change multiplied by the number of lane changes and a predetermined offset distance as a total required distance required to complete the lane changes to the target lane. The lane change control unit 34 then determines the time at which the vehicle 10 will reach a start position nearer to the vehicle by the total required distance than the branch point at which the target lane diverges from the road being traveled by the vehicle 10, as the start timing. The required distance and the offset distance may be prestored in the memory 22.

In the present embodiment, the lane change control unit 34 sets start timing of a start of a lane change earlier when towing of a towed vehicle 11 is detected than when towing of a towed vehicle 11 is not detected. To achieve this, the lane change control unit 34 sets the predetermined offset distance for the case where towing of a towed vehicle 11 is detected (e.g., 500m to 1 km) longer than the predetermined offset distance for the case where towing of a towed vehicle 11 is not detected (e.g., 100m to 500m). Alternatively, the lane change control unit 34 may set the distance required for a single lane change for the case where towing of a towed vehicle 11 is detected to longer than the required distance for the case where towing of a towed vehicle 11 is not detected.

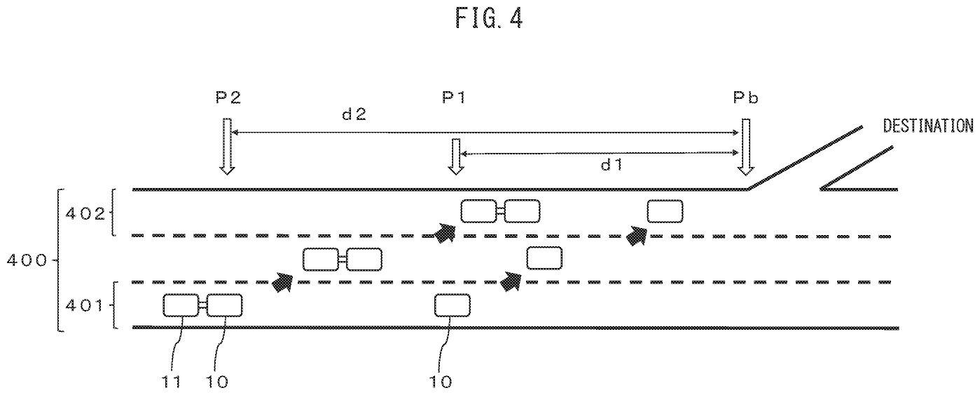

FIG. 4 illustrates the difference in start timing of a lane change between when towing a towed vehicle 11 is not detected and when towing a towed vehicle 11 is detected. In this example, the vehicle 10 is traveling on the rightmost lane 401 of a road 400 with respect to its travel direction. In other words, the lane 401 is a host vehicle lane. Since a lane leading toward a destination of the vehicle 10 diverges from the leftmost lane 402 of the road 400 at a branch point Pb, the lane 402 is a target lane. Thus the vehicle 10 is required to make a lane change to move to the target lane 402 before reaching the branch point Pb.

In the case where towing a towed vehicle 11 is not detected, lane change control of the vehicle 10 will start when the vehicle 10 reaches a position P1 nearer to the vehicle than the branch point Pb by a total required distance d1 for the case where towing of a towed vehicle 11 is not detected. In the case where towing a towed vehicle 11 is detected, lane change control of the vehicle 10 will start when the vehicle 10 reaches a position P2 nearer to the vehicle than the branch point Pb by a total required distance d2 for the case where towing of a towed vehicle 11 is detected. As a result, the vehicle 10 can move to the target lane 402 earlier when towing of a towed vehicle 11 is detected than when towing of a towed vehicle 11 is not detected. This prevents the vehicle 10 that is towing a towed vehicle 11 from moving to the target lane 402 near the branch point Pb, so as to reduce a feeling of pressure relating to another vehicle traveling in an area around the vehicle 10 (hereafter a “vicinity vehicle”), in particular, to a vicinity vehicle traveling on the target lane 402 and a vicinity vehicle trying to make a lane change to the target lane 402 before reaching the branch point Pb. In addition, since the vehicle 10 towing a towed vehicle 11 moves to the target lane 402 at a position away from the branch point Pb, it is easy for a vicinity vehicle to move to the target lane 402 ahead of the vehicle 10. This prevents traffic from being obstructed by a lane change of the vehicle 10 towing a towed vehicle 11.

The lane change control unit 34 compares the latest position of the vehicle 10 measured by the GPS receiver 3 with the start position to determine whether the vehicle 10 has reached the start position. When the vehicle 10 reaches the start position, the lane change control unit 34 determines that the start timing of lane change control has come. When the start timing comes and execution of lane change control starts, the lane change control unit 34 sets a planned trajectory such that the vehicle 10 will move from the host vehicle lane to the target lane. When a planned trajectory is set, the lane change control unit 34 controls components of the vehicle 10 so that the vehicle 10 travels along the planned trajectory. To achieve this, the lane change control unit 34 detects the position of the vehicle 10 at predetermined intervals by processing similar to that executed by the lane detection unit 32, and compares the detected position of the vehicle 10 with the planned trajectory. When the position of the vehicle 10 is on the planned trajectory, the lane change control unit 34 determines the steering angle of the vehicle 10 so that the vehicle 10 moves along the planned trajectory, and controls the steering of the vehicle 10 so that the steering angle is the same as determined. When the measured position of the vehicle 10 is apart from the planned trajectory, the lane change control unit 34 determines the steering angle of the vehicle 10 so that the vehicle 10 approaches the planned trajectory, and controls the steering of the vehicle 10 so that the steering angle is the same as determined.

In the case where there is a vicinity vehicle traveling on the destination lane of the lane change ahead of or beside the vehicle 10, the lane change control unit 34 sets the acceleration or deceleration of the vehicle 10 so that the distance between the vicinity vehicle and the vehicle 10 will not be less than a predetermined distance threshold when the vehicle 10 enters the destination lane. To this end, the lane change control unit 34 determines a relative position and a relative speed between the vehicle 10 and the vicinity vehicle.

To achieve this, the lane change control unit 34 detects the vicinity vehicle by inputting an image obtained from the camera 2 into a classifier. As such a classifier, the lane change control unit 34 can use a classifier similar to that described in relation to the lane detection unit 32. The classifier outputs information for identifying an object region including a vicinity vehicle detected in the inputted image and information indicating the type of the detected vicinity vehicle (e.g., an ordinary passenger car, a large-size vehicle, or a two-wheeler). When a vicinity vehicle is detected, the lane change control unit 34 determines whether the vicinity vehicle is traveling on the destination lane. The bottom position of the object region including the vicinity vehicle is assumed to correspond to the position where the vicinity vehicle is in contact with the road surface. Further, the positions in an image correspond one-to-one to the directions viewed from the camera that generated the image, as described above. Thus the lane change control unit 34 can estimate the distance from the camera 2 to the vicinity vehicle and the direction from the vehicle 10 to the vicinity vehicle, by referring to the bottom position of the object region in the image and parameters of the camera 2, such as the height of the mounted position and the orientation. Alternatively, the lane change control unit 34 may estimate the distance from the camera 2 to the vicinity vehicle, based on the horizontal width of the object region including the vicinity vehicle and the number of reference pixels in an image corresponding to a reference vehicle width of the type of the vicinity vehicle for the case where the distance between the vehicles is a reference distance.

In the case where the vehicle 10 is equipped with a range sensor (not illustrated), the lane change control unit 34 may detect a vicinity vehicle, based on a ranging signal. In this case also, the lane change control unit 34 detects a vicinity vehicle by inputting a ranging signal into a classifier that has been trained to detect a vicinity vehicle from a ranging signal. As the classifier for detecting a vicinity vehicle from a ranging signal, the lane change control unit 34 can use a DNN having architecture of a CNN or SAN type. Alternatively, the lane change control unit 34 may detect a vicinity vehicle in accordance with another technique to detect a vicinity vehicle from a ranging signal. In this case, the lane change control unit 34 determines the direction in which a vicinity vehicle is detected in the ranging signal as the direction from the vehicle 10 to the vicinity vehicle. Further, the lane change control unit 34 determines the distance indicated by the ranging signal regarding this direction as an estimated distance from the vehicle 10 to the vicinity vehicle.

Based on the estimated direction and distance, the lane change control unit 34 estimates the distance from the vehicle 10 to the vicinity vehicle along a direction perpendicular to the travel direction of the vehicle 10 (hereafter referred to as the “inter-vehicle lateral distance” for convenience of description). In the case where the inter-vehicle lateral distance is within a predetermined distance range corresponding to the width of the destination lane at the current position of the vehicle 10 and where the direction from the vehicle 10 to the vicinity vehicle is the same as the bearing of the destination lane relative to the host vehicle lane, the lane change control unit 34 determines that the vicinity vehicle is traveling on the destination lane. The lane change control unit 34 identifies the predetermined distance range at the current position of the vehicle 10 by referring to the high-precision map.

Alternatively, the lane change control unit 34 may detect lane lines represented in an image, together with a vicinity vehicle, by inputting the image into the classifier. In this case, the classifier is trained in advance so that lane lines can also be detected. The lane change control unit 34 identifies a region sandwiched between two lane lines in ascending order of distance from the position of the vehicle 10 in the image in the bearing of the destination of the lane change as a region representing the destination lane in the image. When the bottom of the object region representing the vicinity vehicle is within the region corresponding to the destination lane, the lane change control unit 34 determines that the vicinity vehicle is traveling on the destination lane.

The lane change control unit 34 executes the above-described processing on time-series images generated by the camera 2 or time-series ranging signals generated by the range sensor to estimate the positions of the vicinity vehicle relative to the vehicle 10 at the times of generation of the images or the ranging signals. In addition, the lane change control unit 34 determines the change in the position of the vicinity vehicle relative to the vehicle 10 from the relative positions at the times of generation of individual images or ranging signals in the most recent certain period arranged in chronological order, and estimates the speed of the vicinity vehicle relative to the vehicle 10, based on the change in the relative position.

When multiple vicinity vehicles are detected, the lane change control unit 34 applies a predetermined tracking technique, such as KLT tracking, to track the individual vicinity vehicles over the time-series images or ranging signals. For each vicinity vehicle being tracked, the lane change control unit 34 estimates the position and speed of the vicinity vehicle relative to the vehicle 10.

When the distance between the vehicle 10 and the vicinity vehicle in the travel direction of the vehicle 10, which is determined from the relative position between the vehicle 10 and the vicinity vehicle, is less than the distance threshold, the lane change control unit 34 reduces the speed of the vehicle 10 to below that of the vicinity vehicle, based on the relative speed. When the distance between the vehicle 10 and the vicinity vehicle in the travel direction of the vehicle 10 is not less than the distance threshold, the lane change control unit 34 sets acceleration or deceleration, based on the relative speed, so that the vehicle 10 is as fast as or slower than the vicinity vehicle.

When acceleration or deceleration is set as described above, the lane change control unit 34 sets the degree of accelerator opening or the amount of braking according to the set acceleration or deceleration. At this setting, the lane change control unit 34 may vary the degree of accelerator opening or the amount of braking, depending on whether towing of a towed vehicle 11 is detected. For example, the lane change control unit 34 may set a larger degree of accelerator opening or amount of braking when towing of a towed vehicle 11 is detected than when towing of a towed vehicle 11 is not detected.

The lane change control unit 34 sets the degree of accelerator opening or the amount of braking according to the set acceleration or deceleration. The lane change control unit 34 determines the amount of fuel injection according to the set degree of accelerator opening, and outputs a control signal depending on the amount of fuel injection to a fuel injector of an engine of the vehicle 10. Alternatively, the lane change control unit 34 determines electric power to be supplied to a motor according to the set degree of accelerator opening, and controls a driving circuit of the motor so that the determined electric power is supplied to the motor. Alternatively, the lane change control unit 34 outputs a control signal depending on the set amount of braking to the brake of the vehicle 10.

When the vehicle 10 starts to travel completely inside the target lane, the lane change control unit 34 finishes lane change control. To this end, the lane change control unit 34 determines whether the whole vehicle 10 is within the target lane, by referring to the detected position of the vehicle 10 and the high-precision map or referring to two lane lines demarcating the target lane detected from the image. When the whole vehicle 10 is within the target lane, the lane change control unit 34 determines that the vehicle 10 has started to travel completely inside the target lane.

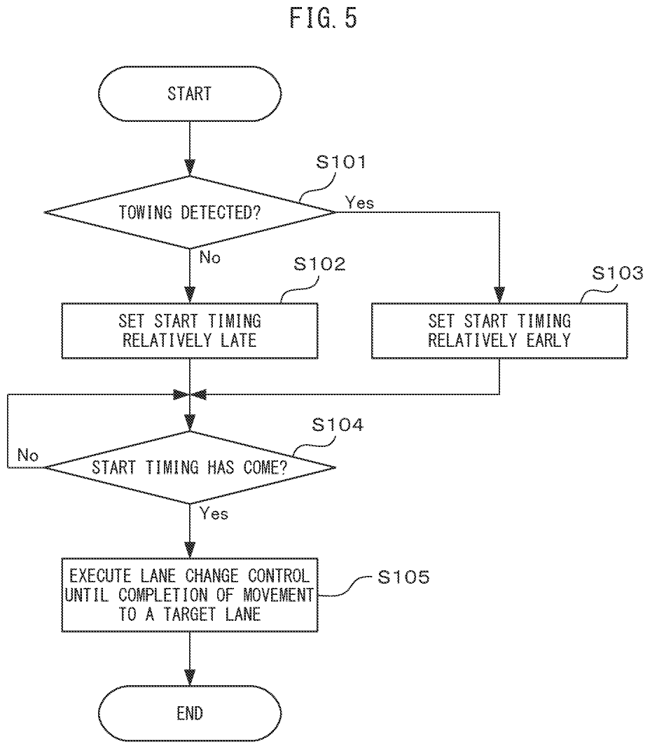

FIG. 5 is an operation flowchart of the vehicle control process. When the determination unit 33 determines to apply lane change control, the processor 23 executes the vehicle control process related to lane change control in accordance with the operation flowchart described below.

The towing detection unit 31 of the processor 23 determines whether towing of a towed vehicle 11 by the vehicle 10 is detected (step S101).

When towing of a towed vehicle 11 is not detected (No in step S101), the lane change control unit 34 of the processor 23 sets start timing of lane change control to relatively late timing (step S102). When towing of a towed vehicle 11 is detected (Yes in step S101), the lane change control unit 34 sets start timing of lane change control to relatively early timing (step S103).

The lane change control unit 34 determines whether the set start timing has come (step S104). When the start timing has not come (No in step S104), the lane change control unit 34 repeats the processing of step S104. When the start timing has come (Yes in step S104), the lane change control unit 34 executes lane change control until the vehicle 10 moves to a target lane (step S105). Thereafter, the processor 23 terminates the vehicle control process.

As has been described above, the vehicle controller sets start timing of lane change control earlier when towing of a towed vehicle is detected than when towing of a towed vehicle is not detected. Thus the vehicle controller can make movement to a target lane completed relatively fast, when the host vehicle is towing a towed vehicle. As a result, the vehicle controller can reduce a feeling of pressure relating to a nearby vehicle due to a large total volume including the host vehicle and the towed vehicle and their relatively slow motion at the time of a lane change, and prevent traffic from being obstructed.

According to a modified example, the start timing of lane change control for the case where towing of a towed vehicle 11 is detected may be adjusted depending on the circumstances of the vehicle 10.

For example, the lane change control unit 34 may set the start timing earlier when the target lane is congested or predicted to be congested than when the target lane is not congested (including the case where congestion is not predicted either). The vehicle 10 towing a towed vehicle 11 moves slowly at the time of a lane change, and the total volume of the towed vehicle 11 and the vehicle 10 is larger than that of the vehicle 10 alone. When the target lane is congested, it is therefore difficult for the vehicle 10 to cut in between vicinity vehicles on the target lane. By setting the start timing of lane change control earlier in this way, the lane change control unit 34 enables the vehicle 10 to finish moving to the target lane early.

Even in this case, the lane change control unit 34 sets the start timing earlier when towing of a towed vehicle 11 by the vehicle 10 is detected than when towing of a towed vehicle 11 by the vehicle 10 is not detected, regardless of whether the target lane is congested.

To determine whether traffic is congested, the lane change control unit 34 estimates the speed of a vicinity vehicle, based on the speed of the vehicle 10 and the relative speed between the vehicle 10 and the vicinity vehicle estimated as described above. When the speed of the vicinity vehicle is less than the regulation speed of the road being traveled by the vehicle 10 by more than a predetermined congestion determination threshold, the lane change control unit 34 determines that traffic is congested. To this end, the lane change control unit 34 may identify the vicinity vehicle traveling on the target lane by comparing the inter-vehicle lateral distance with the distance from the host vehicle lane to the target lane determined from the high-precision map. The lane change control unit 34 may determine whether the target lane is congested, by executing the above-described processing on the vicinity vehicle traveling on the target lane.

Alternatively, the lane change control unit 34 may determine whether the target lane is congested, by comparing a congested section indicated by traffic information received via the wireless communication terminal 5 with the position of the branch point at which movement to the target lane has to be completed. In other words, when the position of the branch point represented in the high-precision map is within the congested section, the lane change control unit 34 determines that the target lane is congested.

Alternatively, for each section predicted to be congested, the position and area of the section and the period during which traffic is predicted to be congested (e.g., a day of the week and time of day) may be prestored in the memory 22. In this case, when the position of the branch point represented in the high-precision map is within a section predicted to be congested at the current time, the lane change control unit 34 determines that the target lane is congested.

The lane change control unit 34 may set start timing of lane change control earlier when weather around the vehicle 10 is poor (e.g., weather that makes the braking distance of the vehicle 10 longer than usual or reduces visibility, such as rain, snow, or fog) than when weather around the vehicle 10 is not poor. By setting the start timing in this way, the lane change control unit 34 can ensure a greater safety margin when weather around the vehicle 10 is poor.

The lane change control unit 34 determines that weather around the vehicle 10 is poor, when a rainfall value measured by a rainfall sensor (not illustrated) mounted on the vehicle 10 is not less than a predetermined poor-weather threshold. Alternatively, the lane change control unit 34 may determine that weather around the vehicle 10 is poor, when the current position of the vehicle 10 is within a poor-weather region indicated by weather information received via the wireless communication terminal 5.

According to these modified examples, the lane change control unit 34 can set the start timing of lane change control appropriately, depending on the circumstances of the vehicle 10 as well as the presence or absence of a towed vehicle.

According to another modified example, the lane change control unit 34 may make earlier setting of the start timing of lane change control for the case where towing of a towed vehicle 11 is detected as an estimated weight of the towed vehicle 11 is larger. Similarly, the lane change control unit 34 may make earlier setting of the start timing of lane change control for the case where towing of a towed vehicle 11 is detected as the volume of the towed vehicle 11 is larger. The volume of the towed vehicle 11 may be prestored in the memory 22. The lane change control unit 34 can start lane change control at more appropriate timing, by adjusting the start timing according to an estimated weight or the volume of the towed vehicle 11 in this way.

The computer program for achieving the functions of the processor 23 of the ECU 7 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present disclosure.

What is claimed is:

1. A vehicle controller comprising:
a processor configured to:
detect that a host vehicle under autonomous driving control is towing a towed vehicle,
detect a host vehicle lane being traveled by the host vehicle among a plurality of lanes included in a road being traveled by the host vehicle,
determine whether the host vehicle is required to make a lane change to a target lane different from the host vehicle lane in a section from the current position of the host vehicle to a predetermined distance away, by referring to a map and the host vehicle lane, and
control the host vehicle to make a lane change from the host vehicle lane to the target lane, when the lane change is required, wherein
the processor sets start timing of a start of the lane change earlier when towing of a towed vehicle by the host vehicle is detected than when towing of a towed vehicle by the host vehicle is not detected.

2. The vehicle controller according to claim 1, wherein the processor sets the start timing earlier when towing of a towed vehicle by the host vehicle is detected in the case where the target lane is congested or predicted to be congested than when towing of a towed vehicle by the host vehicle is detected in the case where the target lane is not congested.

3. The vehicle controller according to claim 1, wherein depending on weather around the host vehicle, the processor adjusts the start timing for the case where towing of a towed vehicle by the host vehicle is detected.

4. A method for vehicle control, comprising:
detecting that a host vehicle under autonomous driving control is towing a towed vehicle;
detecting a host vehicle lane being traveled by the host vehicle among a plurality of lanes included in a road being traveled by the host vehicle;
determining whether the host vehicle is required to make a lane change to a target lane different from the host vehicle lane in a section from the current position of the host vehicle to a predetermined distance away, by referring to a map and the host vehicle lane; and
controlling the host vehicle to make a lane change from the host vehicle lane to the target lane, when the lane change is required, wherein
controlling the lane change from the host vehicle lane to the target lane comprises setting start timing of a start of the lane change earlier when towing of a towed vehicle by the host vehicle is detected than when towing of a towed vehicle by the host vehicle is not detected.

5. A non-transitory recording medium that stores a computer program for vehicle control, the computer program causing a processor mounted on a host vehicle to execute a process comprising:
detecting that the host vehicle under autonomous driving control is towing a towed vehicle;
detecting a host vehicle lane being traveled by the host vehicle among a plurality of lanes included in a road being traveled by the host vehicle;
determining whether the host vehicle is required to make a lane change to a target lane different from the host vehicle lane in a section from the current position of the host vehicle to a predetermined distance away, by referring to a map and the host vehicle lane; and
controlling the host vehicle to make a lane change from the host vehicle lane to the target lane, when the lane change is required, wherein
controlling the lane change from the host vehicle lane to the target lane comprises setting start timing of a start of the lane change earlier when towing of a towed vehicle by the host vehicle is detected than when towing of a towed vehicle by the host vehicle is not detected.
